(19) United States
(12) Patent Application Publication
(10) Pub. No.: US 2024/0047775 A1
(43) Pub. Date: Feb. 8, 2024

(54) LITHIUM ION BATTERY RECYCLING PROCESS UTILIZING MAGNETIC SEPARATION OF ELECTRODE MATERIALS

(71) Applicant: UCHICAGO ARGONNE, LLC, Chicago, IL (US)

(72) Inventors: Albert L. LIPSON, Oak Park, IL (US); Jessica L. DURHAM, Braidwood, IL (US); Jeffrey S. SPANGENBERGER, Naperville, IL (US)

(21) Appl. No.: 17/879,468

(22) Filed: Aug. 2, 2022

(51) Int. Cl. H01M 10/54; H01M 10/0525; H01M 50/46; C22B 1/02; C22B 7/00; C22B 21/00; C22B 15/00; C01B 32/215

(52) U.S. Cl. CPC H01M 10/54; H01M 10/0525; H01M 50/46; C22B 1/02; C22B 7/005; C22B 21/0069; C22B 15/0082; C01B 32/215; C01P 2006/40

(57) ABSTRACT

A method for recovering and recycling lithium battery components comprises shredding used batteries into fragments, recovering electrolyte from the fragments, aspirating the fragments to remove separator membrane fragments from other solid materials, magnetically separating the cathode fragments from the non-magnetic anode fragments on a rare earth roll separator; thermally removing binder and carbon from the cathode fragments, recovering delithiated cathode active material; relithiating the delithiated cathode active material, recovering aluminum foil from the cathode fragments; removing cathode active material from the anode fragments, and recovering copper foil from the anode fragments.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to methods for recycling lithium batteries.

### BACKGROUND

The deployment of Li-ion batteries is dramatically increasing in application areas including portable electronics, electric vehicles, and grid storage. As these recently deployed battery systems begin to reach their end-of-life effective recycling strategies need to be developed. Such processes do not capture the value of the cathode manufacturing process, which amounts to about half the value of the cathode material. Current commercial technologies are focused on recovering the metals from the battery such as Co, Cu and Ni by essentially using the batteries as ore in standard hydrometallurgical and pyrometallurgical approaches. However, this strategy limits the potential revenue in the recycling process. This is especially important for lower metals value cathode materials that are currently being utilized such as lithium nickel manganese cobalt oxide (NMC) with high nickel content, and LiFePO₄ (LFP). Being able to retain the value of the finished cathode material through the recycling process (direct recycling) may be able to increase the revenue significantly and therefore make recycling profitable for some of these lower metals value batteries. There is a need for an efficient direct recycling process that can recover the cathode active material directly, allowing it to be sold for nearly the full value of virgin cathode active material. Many attempts have been made to make such a direct process work, but current processing techniques have significant challenges to overcome to achieve high quality material in a manner that can he scaled up to commercial levels.

Previous work on direct recycling has either focused on hand disassembled batteries or delamination of the electrodes as the first step in the process. Hand disassembly will clearly not work commercially due to the high labor costs. Commercial entities have therefore mostly focused on the processes where electrode delamination occurs early in the process. This delamination is typically achieved via hammer milling or other strong abrasion. These processes can be very effective in removing the materials from the current collector foils; however, such delamination processes typically create a large number of Al and Cu particles that can be difficult and costly to separate later in the process.

Current cathodes for lithium batteries generally are formed from a cathode active composition in a discharged state (i.e., fully lithiated) coated onto a metal foil current collector (e.g., aluminum foil). Lithium and lithium-ion cells and batteries utilize lithium ion (Li⁺) as the charge carrying species of the electrolyte. A typical cathode active composition for a lithium battery comprises particles of a lithium transition metal oxide (or another cathode active material such as lithium iron(3+) phosphate) and carbon (e.g., carbon black) bound to a current collector by a polymeric binder such as poly(vinylidene difluoride) (PVDF).

Lithium battery cathodes are manufactured in sheets, and individual cathodes are cut from the sheets. During battery manufacturing, trimmings from the cathode sheets currently are discarded, despite the high cost of the lithium transition metal oxide component of the cathode. Ideally, it would be desirable to recycle cathode materials from these trimmings, provided the materials can be isolated with the same chemical composition as the cathode material in the pristine trimmings.

Used lithium batteries (also referred to as end-of-life batteries) represent a major potential resource for battery manufacture, provided efficient recycling processes can be developed. One major issue with end-of-life batteries is that the cathodes generally are at least partially charged (i.e., partially delithiated) compared to the pristine (i.e., freshly prepared) cathode active materials. In order to recover a useful cathode material from recycled cathodes, the delithiated materials must also be relithiated.

Anodes for lithium batteries typically comprise a carbon-based material capable of accepting lithium during charging and releasing lithium during discharge. The carbon material (e.g., graphite) is coated on to a copper foil current collector. A typical battery also includes a separator membrane (e.g., a polymeric membrane that is permeable to lithium ion), an electrolyte comprising a lithium electrolyte salt dissolved in a non-aqueous organic solvent, a housing or packaging, conductive tabs or leads for connecting the electrodes to a load, and the like. In a battery recycling process, it is desirable to separate as many components as possible, e.g., the anode current collector, and cathode current collector, separator membranes, graphite, cathode active material, etc.

Current processes for separating lithium-ion battery electrodes and electrode materials (e.g., anode active material on copper foil and cathode active material on aluminum foil) during recycling include a step of removing the electrode active materials from their respective foils and collecting them as a bulk powder (often referred to as “black mass”). This type of process is adequate for current battery recycling processes (e.g., hydrometallurgical and pyrometallurgical) that convert the powders back to purified raw materials (e.g., Ni, Mn, Co, Fe, and or Li salt, oxides, and the like); however, contamination can be an issue for direct recycling processes where materials are regenerated back to more complex materials to be directly reused in preparing new electrodes, cells, and batteries.

Because of problems described above, there are ongoing needs for new methods for separating, recovering and recycling lithium battery components, such as cathode active materials, graphite, current collectors, and separator membranes from lithium battery manufacturing waste and used lithium batteries. The methods described herein address these needs.

### SUMMARY

The lithium battery recycling processes described herein are able to sort out graphite, aluminum, copper, separator, cathode active material, and the like. In addition, thermal relithiation of recovered cathode active material produces a fully discharged (i.e., fully lithiated) cathode active material that can be directly reused in new electrodes and battery cells. The work described herein provides a low cost and scalable process that utilizes the direct recycling approach with sorting of the anode and cathode as an early step in the process. This enables simplified separation of materials into cathode, anode, electrolyte, aluminum, copper, separator, and other materials. Using this methodology, a high purity, typically partially delithiated cathode material is recovered from shredded commercial cells. This cathode material is then relithiated using a solid-state methodology, which provides a material that can be directly reused in new cells. During the process the electrolyte also can be recovered and reutilized in full cells, perhaps with some adjustment to the electrolyte composition. The recovered aluminum and copper current collector materials can be further processed, e.g., by remelting, casting, and rolling, to produce new current collector foils, as well.

A method for recovering and recycling lithium battery components is described herein. In some embodiments, the method comprises the steps of shredding batteries or battery components (e.g., electrodes) to form small fragments, recovering electrolyte, if present, aspirating the solids to remove a majority of the separator membrane fragments from other solid materials, if present, magnetic separation of the magnetic cathode fragments from the non-magnetic battery component fragments, such as the anode, battery pouch, electrode tabs, KAPTON tape, and the like. Preferably, the magnetic separation is performed using a rare earth roll (RE-Roll) separator. The RE-Roll separator comprises a conveyor belt that runs over and is driven by a roller made of a powerful rare earth magnet. The magnetic field at the belt surface in the vicinity of the roller is sufficiently high that even materials that are only weakly attracted to a magnet will adhere to the belt as the material travels around the roller. In use, a material to be separated (typically shredded) is deposited on the conveyor belt, and as the belt is driven over the rare earth magnetic roller, even mildly magnetic materials tend to stick to the belt for a short time as the belt goes over and around the roller. In contrast, materials that are not attracted to the magnet are expelled from the belt by momentum and gravity as the belt goes over the roller. Thus, the magnetically attracted materials (which for convenience we refer to herein as the “magnetic fraction” or “magnetic materials”) drop off the conveyor belt closer to the roll than the other materials (the “non-magnetic” materials or fraction). Neither aluminum foil nor copper foil (the two current collector metals used in lithium battery electrodes) are attracted to the RE-Roll magnet.

In the methods described herein, the anode fragments are not magnetically attracted to the RE-Roll, but the cathode fragments are, because the typical cathode active materials coated on the surface of the aluminum foil current collector, such as lithium nickel manganese cobalt oxides (NMC), LiFePO₄, and the like, have sufficient magnetic susceptibility to be attracted to the RE-Roll and adhere to the belt, even when still physically connected to the aluminum foil current collector. The attraction is strong enough that the shredded cathodes can be separated from the anodes and other non-magnetic materials. After initial separation, a second pass of each fraction (i.e., magnetic and non-magnetic) over the RE-Roll improves the efficiency of separation further.

In initial evaluations, magnetic separation was conducted using shredded commercial grade electrodes (NMC-based cathodes on aluminum foil and graphite-based anodes on copper foil) prepared at Argonne National Laboratory. The electrodes were cut into three different size ranges (e.g., approximately ¼ inch, 0.5 to 1-inch, and 1 to 1.5-inch sizes) and used to evaluate the separation efficiency of the RE-Roll. The electrodes were prepared in sizes similar to those which have generated using an industrial shredder to shred dry pouch cells. Two fractions were collected: the magnetic fraction (material collected closer to the magnetic roll) and non-magnetic fraction (material collected further away from the magnetic roll). Each of these fractions was separately passed over the RE-Roll a second time to improve purity and separation efficiency. The two fractions from the larger sized batches (i.e., 0.5 to 1-inch, and 1 to 1.5-inch fragments) were hand-sorted to determine the purity of the magnetic and nonmagnetic fractions. For the 0.5 to 1-inch electrodes, the magnetic fraction contained cathode (i.e., NMC on aluminum foil) at 99.5% purity while the non-magnetic fraction comprised 99.8% pure anode (i.e., graphite on copper foil). Shredded pouch cells, which provided fragments containing pouch cell casing, polymer separator sheets, and stainless steel, in addition to the anode and cathode electrode, also were evaluated.

Cathode active materials can be delithiated, at least to some extent, in used or end-of-life batteries, and can also be partially delithiated during various phases of battery recycling, depending on the processing steps used. Effective direct recycling of the cathode materials requires some form of relithiation to restore the cathode material to a fully lithiated state, as in the methods described herein. The cathode active material can be relithiated by any convenient method. In some embodiments, the cathode material is relithiated by heating the material with a decomposable lithium compound to reintroduce lithium into the delithiated portion of the cathode active material. In other embodiments, the cathode active material can be relithiated by methods such as hydrothermal relithiation, ionothermal relithiation, molten salt relithiation, electrochemical relithiation, and the like. Relithiated cathode active materials recovered from the process described herein perform surprisingly similar to the pristine cathode material when formed into a cathode laminate and tested in a lithium half-cell. The recovered cathode active materials from the methods described herein also perform significantly better than the corresponding pristine cathode material heated to remove the carbon and binder without relithiation.

In some embodiments, the cathode active material to be recovered or recycled is LiFePO₄ or a lithium transition metal oxide, such as LiMO₂, wherein M is a transition metal of metals (e.g., Ni, Mn, Co or a combination of two or more thereof), or a delithiated form thereof, e.g., Li₁₋ₓMO₂, wherein 0<x<0.5.

The following non-limiting embodiments of the methods described herein are provided below to illustrate certain aspects and features of the compositions and methods described herein.

Embodiment 1 is a process for directly recycling components of lithium batteries. The process comprises the steps of:
(A) shredding lithium batteries and/or scrap from lithium battery manufacturing (e.g., cathode and anode trimmings, laminated cells trimmings, rejected assembled batteries, rejected assembled cells, and the like), optionally under an inert atmosphere, to form battery component fragments;
(B) separating electrolyte, if present, from the fragments by washing the fragments with an organic solvent, optionally under an inert atmosphere;
(C) drying the resulting electrolyte-free fragments from step (B);
(D) removing at least a majority of separator membrane fragments from the resulting dried fragments of step (C) by air aspiration to provide a heavies composition;
(E) magnetically separating the heavies composition on a rare earth roll separator into a magnetic fraction comprising cathode fragments, and a non-magnetic fraction;
(F) removing binder and carbon particles from the cathode fragments in the magnetic fraction (e.g., by heating the magnetic fraction under an oxygen-containing atmosphere at a temperature in the range of about 400 to about 1000° C. for a period of time sufficient to burn off the binder and carbon; by solvent extraction, or by other methods known in the art);
(G) recovering the cathode active material remaining after step (F);
(H) relithiating the cathode active material as needed to restore the lithium content (e.g., by adding a decomposable lithium-containing compound thereto and heating the resulting mixture at a temperature in the range of about 400 to about 1000° C. for a period of time sufficient to fully lithiate the partially delithiated cathode active material (e.g., heating at about 750° C. for about 8 hours); or by other methods known in the art, such as hydrothermal relithiation, ionothermal relithiation, molten salt relithiation, electrochemical relithiation, and the like); and
(I) recovering the resulting relithiated cathode active material (e.g., by sieving the powdered cathode active material away from the aluminum foil).

Embodiment 2 is the process of embodiment 1, further comprising adjusting solvent content and concentration of the electrolyte removed in step (B) to obtain a target electrolyte composition.

Embodiment 3 is the process of embodiment 1 or 2, further comprising washing the relithiated cathode active material recovered in step (I) with water.

Embodiment 4 is the process of any one of embodiments 1 to 3, further comprising annealing the relithiated cathode active material at a temperature of about 200 to about 1000° C. for up to about 24 hours, e.g., to remove any protons left after washing with water, and/or to stabilize the crystal structure of the relithiated cathode material (e.g., to restore the layered structure of a layered NMC cathode active material).

Embodiment 5 is the process of any one of embodiments 1 to 4, further comprising separating and recovering aluminum from the relithiated cathode active material.

Embodiment 6 is the process of any one of embodiments 1 to 5, wherein the organic solvent in step (B) is selected from the group consisting of acetonitrile, dimethyl formamide, tetrahydrofuran, diethyl carbonate, ethyl methyl carbonate and dimethyl carbonate.

Embodiment 7 is the process of any one of embodiments 1 to 5, wherein the organic solvent in step (B) is diethyl carbonate (DEC).

Embodiment 8 is the process of any one of embodiments 1 to 7, wherein the decomposable lithium-containing compound is a decomposable lithium salt, and the cathode active material is combined with about 1 to about 50 wt % of the decomposable lithium salt.

Embodiment 9 is the process of any one of embodiments 1 to 8, wherein the binder and carbon are removed by heating under an oxygen-containing atmosphere to a temperature of about 400 to 1000° C. at a heating rate of about 30 to about 300° C./hour.

Embodiment 10 is the process of any one of embodiments 1 to 9, wherein the magnetic fraction obtained from step (E) is passed over the rare earth roll at least one additional time to separate additional non-magnetic fragments present therein.

Embodiment 11 is the process of any one of embodiments 1 to 10, wherein the non-magnetic fraction obtained from step (E) is passed over the rare earth roll at least one additional time to separate additional magnetic cathode fragments present therein.

Embodiment 12 is the process of any one of embodiments 1 to 11, wherein the decomposable lithium-containing compound comprises at least one salt selected from the group consisting of lithium hydroxide hydrate, lithium carbonate, lithium nitrate, and a lithium salt of an organic acid.

Embodiment 13 is the process of any one of embodiments 1 to 12, wherein the decomposable lithium-containing compound comprises lithium hydroxide hydrate.

Embodiment 14 is the process of any one of embodiments 1 to 13, wherein the cathode active material comprises a material of empirical formula LiMO₂, wherein M comprises at least one transition metal.

Embodiment 15 is the process of embodiment 14, wherein M comprises at least one transition metal selected from the group consisting of Ni, Mn, and Co.

Embodiment 16 is the process of any one of embodiments 1 to 15, wherein the heating in step (F), step (H), or both steps (F) and (H) are performed in a furnace, a fluidized bed reactor, or a rotary kiln.

Embodiment 17 is the process of any one of embodiments 1 to 16, further comprising the steps of:
(J) washing the non-magnetic fraction from step (E) with water;
(K) drying solid materials remaining after step (J);
(L) removing additional separator membrane from the resulting dried solids from step (K) by aspiration with a stream of gas to produce a second heavies composition; and (M) sieving the second heavies composition from step (L) to separate and recover copper from any other remaining materials in the heavies fraction.

Embodiment 18 is the process of embodiment 17, further comprising recovering the anode active material from the water after step (J).

Embodiment 19 is the process of any one of embodiments 1 to 18, wherein the battery fragments have an average size in the range of about 0.25 to about 2 inches.

Embodiment 20 is a method for separating cathodes from anodes in a lithium battery recycling process, wherein the cathodes comprise a cathode active material and carbon particles bound to an aluminum current collector by a polymeric binder; and the anodes comprise an anode active material coated on a copper current collector. The method comprises magnetically separating mixed fragments of anodes and cathodes on a rare earth roll separator apparatus into a magnetic fraction comprising cathode fragments, and a non-magnetic fraction comprising anode fragments.

Embodiment 21 is the method of embodiment 20, wherein the fragments have an average size in the range of about 0.25 to about 2 inches.

Embodiment 22 is the method of embodiment 20 or 21, wherein the magnetic fraction is magnetically separated at least one more time on the rare earth roll separator to remove additional non-magnetic material remaining in the magnetic fraction.

Embodiment 23 is the method of any one of embodiments 20 to 22,
further comprising:
removing binder and carbon particles from the cathode fragments, e.g., by heating the magnetic fraction under an oxygen-containing atmosphere at a temperature in the range of about 400 to about 1000° C. for a period of time sufficient to burn off the binder and carbon particles leaving a delithiated cathode active particles and aluminum foil fragments; or by other methods;
recovering the cathode active material;
relithiating the cathode active material, e.g., by adding a decomposable lithium-containing compound thereto and heating the resulting mixture at a temperature in the range of about 400 to about 1000° C. for a period of time sufficient to fully lithiate the partially cathode active material; or by other methods;
recovering the resulting relithiated cathode active material; and
recovering the aluminum foil fragments.

Embodiment 24 is the method of any one of embodiments 20 to 23, wherein the non-magnetic fraction is magnetically separated at least one more time on the rare earth roll separator to remove additional magnetic material remaining in the non-magnetic fraction.

Embodiment 25 is the method of any one of embodiments 20 to 24, further comprising:
washing the non-magnetic fraction with water in an acoustic mixer to remove the anode active material from the copper foil; and
recovering the copper foil.

Embodiment 26 is the method of embodiment 25, further comprising:
recovering the anode active material.

Embodiment 27 is the method of any one of embodiments 20 to 26, wherein the anode active material is graphite.

Embodiment 28 is a cathode for a lithium battery comprising the relithiated cathode active material recovered the process of any one of embodiments 1 to 19 and carbon particles coated on an aluminum current collector with a polymeric binder.

Embodiment 29 is an electrolyte for a lithium electrochemical cell comprising the electrolyte recovered in the process of any one of claims 2 to 19.

Embodiment 30 is a lithium electrochemical cell comprising an anode, the cathode of embodiment 28, a lithium conductive separator membrane between the anode and the cathode, and a lithium containing electrolyte contacting the anode, the cathode, and the separator.

Embodiment 31 is a lithium electrochemical cell comprising an anode, a cathode, a lithium conductive separator membrane between the anode and the cathode, and a lithium containing electrolyte contacting the anode, the cathode, and the separator, wherein the electrolyte comprises the electrolyte recovered from the process of any one of embodiments 2 to 19.

Embodiment 32 lithium battery comprising a plurality of the electrochemical cells of embodiment 30 electrically connected in series, in parallel, or in both series and parallel.

Embodiment 33 lithium battery comprising a plurality of the electrochemical cells of embodiment 31 electrically connected in series, in parallel, or in both series and parallel.

In the process and method embodiments described above, the various materials and fragments can be subjected to other recycling processes not specifically enumerated above, in order to improve separations or purity of the isolated materials, and the like. For example, optical sorting for color can be used in combination with the magnetic sorting/separation, e.g., to enhance the separation of copper-containing fragments from the other materials. Similarly, recovered aluminum and/or copper can be purified to any desired purity by well known metallurgical processes; recovered solvents from the electrolyte can be purified to any desired purity by distillation or other known methods; and the like.

### BRIEF DESCRIPTION OF THE DRAWINGS

FIG. 1 shows a block diagram for an embodiment of the recycling process.

FIG. 2 shows (a) a pie chart of the composition (via hand-sorting) of the light fraction from the aspiration step via hand sorting; and (b) a photograph of the hand sorted materials.

FIG. 3 shows pie charts of the compositions after RE-Roll processing, as determined by hand sorting, of (a) the magnetic fraction; and (b) the nonmagnetic fraction.

FIG. 4 shows pie charts of the compositions after RE-Roll processing of (a) the recovered cathode; (b) the copper foil (<5.6 mm size fraction); (c) other materials (>5.6 mm size); and (d) the overall yield of the different fractions recovered.

FIG. 5 provides a particle size distribution plot for recovered, relithiated NMC622 cathode active material.

FIG. 6 provides a plot of discharge capacity versus cycle number for lithium half cells comprising recovered, relithiated NMC622 cycled at sequential rates of C/10, C/20, C/10, C/5, C/2, 1C, 2C, and C/3, showing a capacity of 177 mAh/g at C/10 cycling rate and 167 mAh/g at C/2 cycling rate.

FIG. 7 provides a plot of discharge capacity versus cycle number for coin cells with Gen2 electrolyte (1.2 M LiPF₆ in 3:7 EC:EMC) at C/3 cycling rate (initial rate of C/10) with cathodes comprising recovered, relithiated NMC622, showing an initial capacity of 161 mAh/g at C/10 cycling rate and 152 mAh/g at C/3 cycling rate.

FIG. 8 provides a plot of discharge capacity versus cycle number for full cells with NMC622 cathode in pristine Gen2 electrolyte versus recovered electrolyte comprising 1 M LiPF₆ in 1:1 EC:DEC showing similar performance for the two electrolytes.

FIG. 9 depicts a schematic representation of an electrochemical cell.

FIG. 10 depicts a schematic representation of a battery consisting of a plurality of cells connected electrically in series and in parallel.

### DETAILED DESCRIPTION

The primary processing stream in the lithium battery recycling processes described herein involves shredding batteries and/or battery components; removing any electrolyte that may be present in the shredded battery fragments; aspirating away separator membrane from the fragments; separating the fragments into magnetic and non-magnetic fractions on an RE-Roll separator; removing binder and carbon from the cathode fragments present in the magnetic fraction; relithiating the cathode active material; and recovering the relithiated cathode active material in a form useful for manufacturing new lithium batteries.

In some embodiments, the recycling process includes one of more of the additional steps of adjusting the solvent content and/or concentrations of the electrolyte to obtain a target electrolyte composition; washing the resulting relithiated cathode active material with water; annealing the resulting relithiated cathode active material at a temperature sufficient to stabilize the crystal structure thereof; and/or recovering aluminum.

Some embodiments of the recycling process described herein includes the additional steps of washing the non-magnetic fraction with water, preferably in an acoustic mixer to separate the graphite from the underlying copper current collector; drying the solid fragments of copper foil and other materials); aspirating the resulting dried fragments with a stream of gas (e.g., air) to remove additional separator membrane therefrom, thereby producing a second heavies composition; separating any liberated cathode material using the RE-Roll; and sieving the second heavies composition to separate and recover copper foil from any other remaining materials in the heavies fraction. Optionally, the anode active material, e.g., graphite, can be recovered from the water after the acoustic washing and sieving.

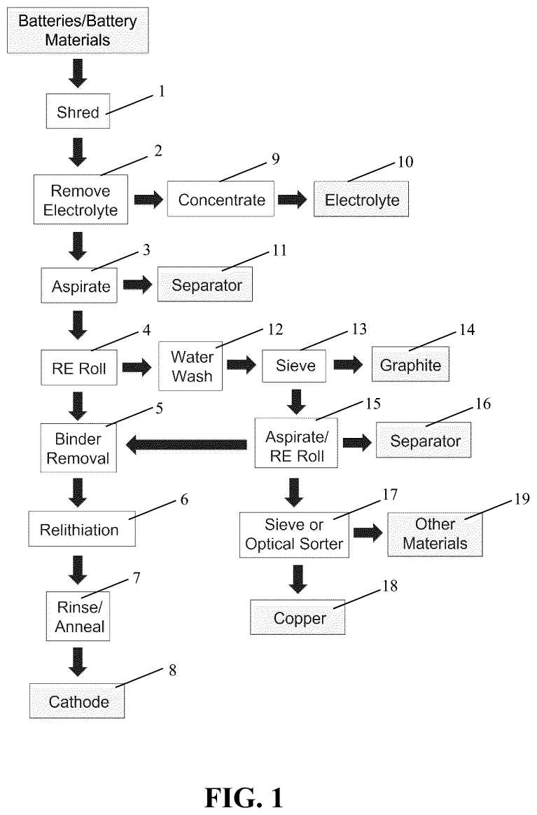

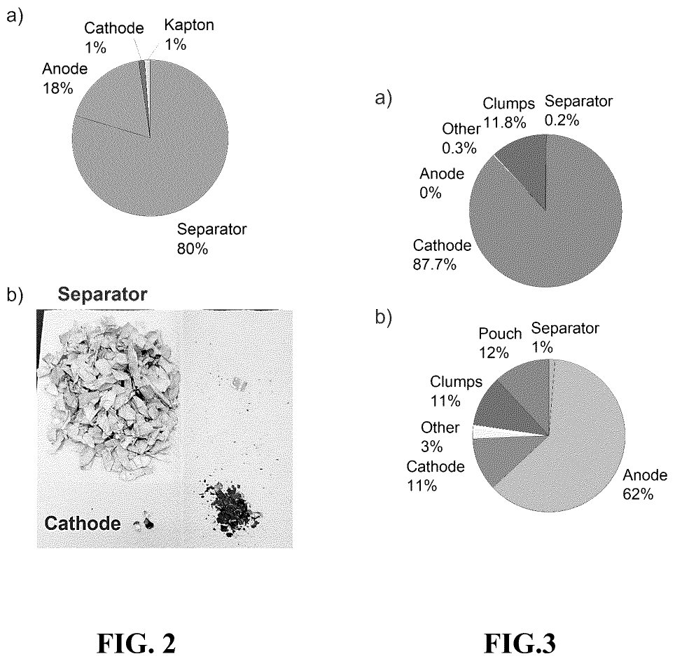

FIG. 1 provides a block diagram outlining an embodiment of a recycling process for directly recycling components of lithium batteries (e.g., end-of-life batteries, waste batteries and components from battery manufacturing, and the like), wherein the batteries typically comprise: a cathode comprising a cathode active material (e.g., a fully or partially delithiated cathode material) and carbon particles bound to an aluminum foil current collector by an organic binder; an electrolyte comprising a lithium electrolyte salt dissolved in a non-aqueous solvent; a polymeric separator membrane; and an anode comprising an anode active material (e.g., a particulate carbon material such as graphite) coated on a copper foil current collector.

The process illustrated in FIG. 1 includes the main process stream steps of (1) shredding batteries or battery components under an inert atmosphere; (2) removing electrolyte from the resulting shredded battery fragments and drying the fragments; (3) aspirating the dried electrolyte-free fragments from step (2) with a stream of gas (e.g., air) to remove at least a majority of the separator membrane therefrom, thereby leaving a first heavies composition; (4) magnetically separating the first heavies composition on a RE-Roll separator apparatus into a magnetic fraction comprising cathode fragments, and a non-magnetic fraction comprising anode fragments and other non-magnetic materials; (5) removing binder and carbon from the cathode fragments; (6) relithiation of the cathode active material; (7) rinsing the relithiated cathode active material with water, followed by annealing; and (8) recovering the relithiated, annealed cathode active material.

In addition, electrolyte removed in step (2) is concentrated to remove or reduce the volume of the solvent used to wash away the electrolyte, and the solvent composition is adjusted to a desired target electrolyte composition in optional step (9); and then in step 10, the target electrolyte is recovered. After step (3), aspirated separator fragments can be recovered in step (11). After step (4), the non-magnetic fraction is acoustically washed with water to separate graphite from the copper foil current collector in optional step (12); the material is sieved to separate the fine particle graphite from the larger fragments comprising copper foil current collector fragments, additional separator fragments, and the like in step (13); and the graphite can be recovered in step (14).

Optional step (15), comprises aspirating the larger fragments retained on the sieve in step (12) with a stream of gas (e.g., air) to remove at additional separator membrane therefrom, thereby leaving a second heavies composition; and subjecting the second heavies composition to RE-Roll separation; and finally, the additional separator is recovered in step (16). Optional step (17) is separating copper and other materials (e.g., by sieving, optical sorting, and the like) from the second heavies composition; step (18) is recovering the copper; and step (19) is recovering the other materials. Optionally, the magnetic fraction from the RE-Roll separation in step (15) can be fed back into the main process stream into step (5).

As described above, the recycling process begins with shredding the batteries, or battery manufacturing scraps, typically under an inert atmosphere, such as argon or nitrogen. The batteries and/or scraps should ideally be of the same type, i.e., all of the batteries and scraps should have the same cathode active material, the same electrolyte, and the like. The shredded fragments can then be exposed to air briefly, if necessary, prior to recovery of the electrolyte. The shredding can be performed in a shear shredder, such as a dual shaft shredder, to produce fragments having an average size in the range of about 0.25 inches to about 2 inches, preferably less than about 0.5 inches.

The electrolyte, when present, is removed by washing the fragments with a solvent that is miscible with the solvent of the electrolyte in the used batteries, and in which the lithium salt present in the electrolyte is soluble. In the examples described herein, the solvent used was diethyl carbonate. The washing of the electrode fragments can be performed in a mixer under an inert atmosphere. In preliminary laboratory evaluations with pouch cells, the electrolyte was found to not contain significant amounts of hydrofluoric acid despite the brief air exposure while it was still in contact with the electrode materials. This is assumed to be caused by residual lithium species on the anode reacting with any formed hydrofluoric acid. After rinsing, the so-formed dilute electrolyte can be reconcentrated and reformulated to create a working Li-ion battery electrolyte. For example, the solvent composition and salt concentration can be adjusted to match a desired target electrolyte formulation.

The rinsed fragments are then dried, leaving a shredded mixture of electrode laminate fragments from both the cathodes and anodes, separator membrane fragments, clumps (e.g., multilayered material containing several different components of the batteries), cell packaging material, such as pouch casing material if pouch cells are the type of batteries being recycled, other cell components that may be present in the batteries, such as electrode tabs, KAPTON, and fines comprising small particles from the electrode coatings, for example. Fines from the shredding process can then be removed to reduce contamination, e.g., by sieving.

At this stage in the recycling process it is best to remove as much of the separator as possible as it can interfere with the anode/cathode separation. This is done using what is known as aspiration. In preliminary evaluations, the collected separator material is approximately 80% separator, with the main impurity being small bits of anode electrode and a few sheets of copper foil. Air aspiration uses a stream of air across a failing cascade of the dried shredded battery components remaining after electrolyte separation. The air blows lower density/thinner materials such as shredded separator membrane away from the bulk of the solid materials due to differences in drag forces of the components. Air aspiration includes processes performed by devices such as air-legs, gravity tables, air tables, destoners, and the like. These processes can remove low density-thin components such as typical separator membranes (also known as separators) from the higher density electrode components.

After aspiration, the “heavies” fraction is then processed through an RE-Roll separator. The high strength magnet of the RE-Roll can interact strongly enough with the cathode active material on the aluminum cathode current collector to cause the cathode fragments to stick to the conveyor belt of the RE-Roll system as the belt moves over the magnet. This enables a high degree of sorting as shown in FIG. 3, with the only non-cathode material being clumps of multilayered materials (i.e., cathode fragments with other materials stuck to the fragments) and some separator material. Some separator membrane typically gets sorted as magnetic mainly due to electrostatic attraction to the belt. Depending on the position of the RE-Roll splitter (the barrier that helps segregate the magnetic and non-magnetic process streams), the clumped material can either be sorted as magnetic or nonmagnetic. This also can depend on the face of the clump that is closest to the conveyor belt. There also is some cathode material that is sorted as nonmagnetic, which is due to how the cathode material sits on the belt. Some material may be crinkled, or separator material may be attached to the side of the cathode facing the belt, preventing it from getting close enough to the magnet to adhere sufficiently. A larger diameter magnet, as would be used commercially, can improve this sorting by enabling better magnet foil contact, and higher fields further from the magnet's surface. Multiple passes of the magnetic and non-magnetic fractions through the RE-Roll, e.g., in separate passes or with RE-Rolls in series, can improve separation even further.

RE-Roll separators are well known in the recycling art, and are available from a variety of manufacturers includes, e.g., Bunting Redditch, Eriez Manufacturing Company, and Jaykrishna Magnetics). RE-Roll separators typically have a rare earth magnet (e.g., a neodymium-boron-iron rare earth permanent magnet) with a field strength in excess of 21,000 gauss at the poles, and belts with a thickness of about 5 to 10 thousandths of an inch (e.g., made form poly(p-phenylene terephthalamide) (KEVLAR) with a polytetrafluoroethylene (TEFLON) coating). The RE-Roll separator can include a single separator stage (belt and RE-roller) or can comprise multiple separator stages in series, in parallel, or both. A splitter arrangement is used to segregate the separated fractions (e.g., magnetic and non-magnetic) into two streams. Multiple passes of each stream can improve separation efficiency. In addition, the belt velocity/roller rotation rate can be adjusted to optimize separation of a given shredded battery process stream. The shredded battery fragments are fed onto the belt from a feeder hopper, which can include a vibratory feeder to aid in delivery of the shredded battery material to the belt in an even layer.

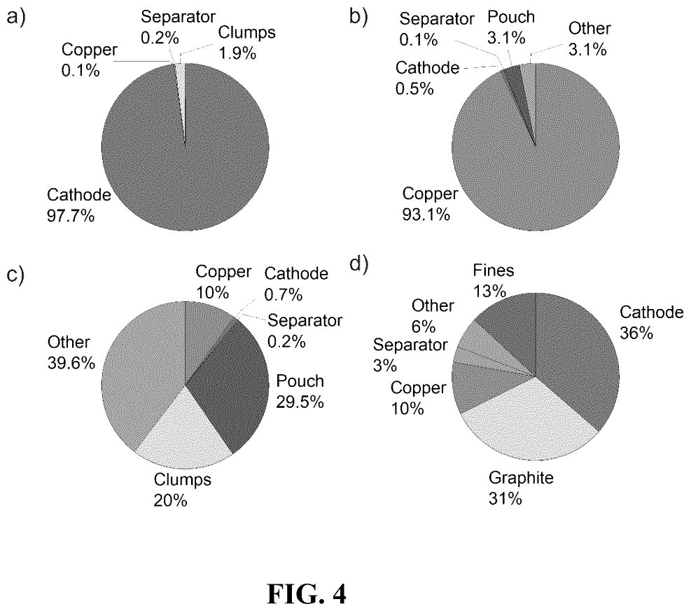

The anode fraction (FIG. 3, panel (b)) can be further processed to remove the graphite from the copper foil. In cycled cells, it is straightforward to remove the anode film by mixing it in water. Preferably, the material is mixed with water in an acoustic mixer, which aids in removing the anode coating from the copper foil. The anode material (e.g., graphite) can then be collected by simply sieving out the foils and other remaining materials. The slurry containing the graphite can then be filtered and dried to obtain the powder that can be used in further recycling processes. This process also effectively breaks up the remaining clumped material, enabling liberation of the remaining cathode foil fragments. Meanwhile the water does not effectively delaminate the cathode material. This leaves a mixture of cathode material on aluminum foil, copper foil, pouch material, separator and other components. This mixture can be separated again by aspiration and the rare earth roll to collect the separator and cathode, respectively. From this process, nearly pure cathode foils are obtained as shown in FIG. 4, panel (a).

With sufficiently strong mixing in an acoustic mixer the copper foil is found to fold up into smaller balls. This effect can be exploited to enable separation of the pouch material from the copper foil by simply sieving at 5.6 mm. After this process, a high purity copper fraction is obtained along with a fraction containing most of the other materials in the cell as shown in FIG. 4, panels (b) and (c). The high purity copper fraction can be further improved via a wide range of processes including optical sorting or other mechanical separation techniques. The other materials can be sold as something similar to zorba from automobile shredding, as it will constitute a mixture of aluminum, copper, and nickel (from the tabs) if reduced to its metals content. Some clumps remain in these fractions, which are mainly the foils near the tabs that are mechanically bonded together and are therefore nearly impossible to separate.

The overall yields of the various fractions are summarized in FIG. 4, panel (d). There was a substantial amount of recovered fines, which are suitable for processing using hydrometallurgical or pyrometallurgical approaches to recover any metals.

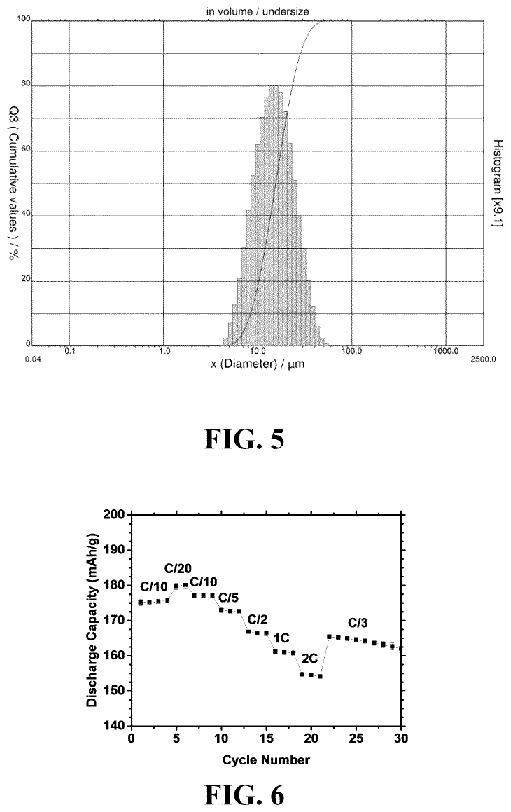

The cathode fraction is further processed into working cathode active material through a series of processing steps. The first step is to remove the binder and carbon black from the material, which can be easily achieved by heating the material to 500° C. inside a rotary kiln or similar heater, in air. After that, the cathode material can be sieved out and the Li content analyzed. In the particular batteries that were evaluated, the cathode active material was found to have a Li to transition metal ratio of 0.92. The approximate amount of LiIH·H₂O required to relithiate the cathode active material can be calculated based on a minimum of 8 wt. % LiIH·H₂O needed to compensate for the PVDF binder burning plus 0.5 wt. % for each percent that the Li to transition metal ratio that is below 1.05. For the materials tested, that translates to about 15 wt. % of LiIH·H₂O that needed to be added. After mixing and heating at 750° C. for 8 hr the material has its structure restored. However, after this process it is typically found that the residual lithium content is high on the cathode's surface. Additional rinsing and reannealing steps were used to remove this excess lithium. The resulting material was then utilized in both half and full cells with the results summarized in FIG. 5, as is discussed in more detail in the examples provided below.

As used herein, the terms “lithium cell” and “lithium battery” encompass cells and batteries in which the anode is lithium metal (sometimes also referred to as a “lithium half-cell”); while the terms “lithium-ion cell” and “lithium-ion battery” encompass cells and batteries in which the anode is something other than lithium metal (e.g., carbon, silicon, etc.). For convenience, the terms “lithium battery”, “lithium-ion battery”, and grammatical variations thereof, are used interchangeably herein, unless it is clear from the context that the more specific designation is meant. Similarly, the terms “lithium cell”, “lithium-ion cell”, and grammatical variations thereof, also are used interchangeably herein, unless it is clear from the context that the more specific designation is meant. The term “delithiated” is used herein to describe a cathode or cathode compound means that the cathode or cathode material contains less than its full capacity of lithium ions. Such delithiated materials may still retain some lithium within the structures thereof. As used herein, the term “relithiate” refers to adding lithium back into a delithiated material to bring it to its full discharged state, or at least substantially so.

The phrase “delithiated cathode active material” and grammatical variations thereof refer to a lithium battery cathode active material comprising less than its full capacity of lithium ion (i.e., less lithium than in its fully lithiated (fully discharged) state, and encompasses cathode active materials in which all electrochemically exchangeable lithium ion have been removed, as well as materials in which only a portion of electrochemically exchangeable lithium has been removed.

As used herein, the term “polymeric binder” refers to any polymer that can be utilized as a binder in a lithium battery, such as poly(vinylidene difluoride) which is also referred to as poly(vinylidene fluoride) or PVDF, copolymers comprising vinylidene difluoride monomer units, polymers or copolymers comprising tetrafluoroethylene monomer units, polymers or copolymers comprising hexafluoropropylene monomer units, fluorinated polyimides, carboxymethylcellulose (CMC), and the like.

As used herein, a structurally-integrated composite metal oxide is a material that includes domains (e.g., locally ordered, nano-sized or micro-sized domains) indicative of different metal oxide compositions having different crystalline forms (e.g., layered or spinel forms) within a single particle of the composite metal oxide, in which the domains share substantially the same oxygen lattice and differ from each other by the elemental and spatial distribution of metal ions in the overall metal oxide structure. Structurally-integrated composite metal oxides are different from and generally have different properties than mere mixtures of two or more metal oxide components (for example, mere mixtures do not share a common oxygen lattice).

A cathode composition for a lithium battery typically comprises carbon (e.g., carbon black, acetylene black, graphite, carbon fibers, carbon nanotubes, carbon nanofibers, and the like), a polymeric binder (e.g., PVDF), and a cathode active material.

The added lithium-containing compound used to thermally relithiate the cathode material preferably is present in the relithiation reaction mixture at a concentration of about 1 to about 50 percent by weight (wt %), based on weight of the cathode active material present in the reaction mixture. During processing, the reaction mixture preferably is heated to a temperature of about 400 to 1000° C. at a heating rate in the range of about 30 to about 300° C./hour, and can be maintained at the temperature of about 400 to 1000° C. prior to cooling, if desired. In some embodiments, the relithiation step is performed at about 475 to about 750° C. (e.g., at about 500, 700, or 750° C.).

In the methods described herein, the specific temperature, heating rate, and amount of lithium compound to be added to delithiated cathode material for the relithiation step is selected based on the particular cathode composition to be treated, using routine and well-known chemical process optimization principles. For example, highly delithiated cathode compounds likely will require more added lithium-containing compound and perhaps higher temperature than treatment of similar compositions comprising a more-lithiated cathode active material. Similarly, different lithium transition metal oxide cathode materials may require different temperatures, heating rates and the like, due to inherent differences in, e.g., the rates and activation energies of the chemical reactions involved.

The heating required for thermal binder removal and for relithiation can be accomplished in any type of reactor capable of achieving the temperatures necessary for the reactions. Because some binders, such as PVDF, are fluorinated and release fluoride and HF upon being heated to the high temperatures in air, the reactor may need to be lined with or made of a fluoride resistant alloy such as a nickel-chromium alloy, a refractory lining, or other such materials, which are well known in the chemical processing arts. The reactor preferably provides for mixing during the processing, such as a fluidized bed reactor, rotary kiln, and the like.

In some embodiments, the cathode active material to be recovered (or the equivalent lithiated form of a cathode material to be recycled from used batteries) comprises, in its fully lithiated state, a layered lithium metal oxide cathode material such as LiMO₂ wherein M comprises one or more transition metals (e.g., Mn, Ni, Co or a combination thereof), for example, a layered lithium nickel-manganese-cobalt oxide such as LiNi_{0.33}Mn_{0.33}Co_{0.33}O₂ (also known as “NMC333” or “NMC111”), LiNi_{0.5}Mn_{0.3}Co_{0.2}O₂ (also known as “NMC532”), LiNi_{0.6}Mn_{0.2}Co_{0.2}O₂ (also known as “NMC622”), and similar materials. In other embodiments, the cathode can comprise a spinel lithium metal oxide such as, e.g., Li₂M′₂O₄ wherein M′ comprises one or more transition metals (e.g., Mn, Ni, Co or a combination thereof); a structurally integrated layered-layered (LL) lithium metal oxide such as xLi₂MnO₃·(1-x)LiMn_{y}M_{1-y}O₂ wherein 0<x<1, 0≤y≤1, M=Ni, Co, or Ni and Co; a structurally integrated layered-spinel (LS) lithium metal oxide such as, e.g., xLi₂MnO₃·(1-x)Li₂Mn_{y}M_{2-y}O₄ wherein 0<x<1, 0≤y≤2, M=Ni, Co, or Ni and Co; a structurally integrated layered-layered-spinel (LLS) lithium metal oxide such as z[xLi₂MnO₃·Li₂Mn_{y}M_{2-y}O₄](1-z)Li₂M′₂O₄ wherein 0<x<1, 0≤y≤1, 0<z<1, M=Ni, Co, or Ni and Co, and M′=Mn, Ni, Co or a combination thereof (e.g., 0.85[0.25Li₂MnO₃(0.75)LiMn_{0.375}Ni_{0.375}Co_{0.25}O₂]·0.15Li₂M′₂O₄ wherein M′=a combination Mn, Ni, and Co), and the like. In yet other embodiments, the cathode active material can be any other lithium transition metal oxide cathode active material used in lithium-ion batteries, such as LiFePO₄, a lithium cobalt aluminum oxide (LCA), a lithium manganese aluminum oxide (LMA) and the like, provided the cathode active material has a magnetic susceptibility sufficient to allow the shredded cathode material to separate from non-magnetic components on an RE-Roll separator.

The recovered and recycled cathode active materials provided by the processes described herein can be utilized in cathodes for new batteries. Cathodes typically are formed by combining a powdered mixture of the active material and some form of carbon (e.g., carbon black, with a binder such as (polyvinylidene difluoride (PVDF), carboxymethylcellulose, and the like) in a solvent (e.g., N-methylpyrrolidone (NMP) and the resulting mixture is coated on a conductive current collector (e.g., aluminum foil) and dried to remove solvent and form an active layer on the current collector.

Cathodes comprising the recovered and recycled lithiated cathode active materials and recovered electrolytes (with appropriate adjustments to the electrolyte solvent, if needed) described herein can be used to manufacture new lithium-ion electrochemical cells. Such cells typically comprise the cathode, an anode capable of reversibly releasing and accepting lithium or lithium-ion during discharging and charging, respectively, and a porous separator between the cathode and anode, with an electrolyte in contact with both the anode and cathode, as is well known in the battery art. A battery can be formed by electrically connecting two or more such electrochemical cells in series, parallel, or a combination of series and parallel. Electrochemical cells and battery designs and configurations, anode and cathode materials, as well as electrolyte salts, solvents and other battery or electrode components (e.g., separator membranes, current collectors), which can be used in the electrolytes, cells and batteries described herein, are well known in the secondary battery art, e.g., as described in “Lithium Batteries Science and Technology” Gholam-Abbas Nazri and Gianfranco Pistoia, Eds., Springer Science+Business Media, LLC; New York, NY (2009), which is incorporated herein by reference in its entirety (Nazri 2009).

Processes used for manufacturing lithium cells and batteries also are well known in the art. The active electrode materials are coated on both sides of metal foil current collectors (typically copper for the anode and aluminum for the cathode) with suitable binders such as polyvinylidene difluoride and the like to aid in adhering the active materials to the current collectors. Cell assembly typically is carried out on automated equipment. The first stage in the assembly process is to sandwich a separator between the anode and the cathode. The cells can be constructed in a stacked structure for use in prismatic cells, or a spiral wound structure for use in cylindrical cells. The electrodes are connected to terminals and the resulting sub-assembly is inserted into a casing, which is then sealed, leaving an opening for filling the electrolyte into the cell. Next, the cell is filled with the electrolyte and sealed under moisture-free conditions.

Once the cell assembly is completed the cell typically is subjected to at least one controlled charge/discharge cycle to activate the electrode materials and in some cases form a solid electrolyte interface (SEI) layer on the anode. This is known as formation cycling. The formation cycling process is well known in the battery art and involves initially charging with a low voltage (e.g., substantially lower that the full-cell voltage) and gradually building up the voltage. The SEI acts as a passivating layer, which is essential for moderating the charging process under normal use. The formation cycling can be carried out, for example, according to the procedure described in Long et al. J. Electrochem. Soc., 2016; 163 (14): A2999-A3009, which is incorporated herein by reference in its entirety. This procedure involves a 1.5 V tap charge for 15 minutes at C/3 current limit, followed by a 6-hour rest period, and then 4 cycles at C/10 current limit, with a current cutoff (i≤0.05 C) at the top of each charge.

Electrodes comprising the recycled or recovered lithiated cathode active materials described herein, can be utilized with any combination of anode and electrolyte in any type of rechargeable battery system that utilizes a non-aqueous electrolyte. Anodes for the electrochemical cells and batteries typically comprise materials that can reversibly accept and release lithium during charging and discharging, respectively, such as carbon (e.g., carbon black), silicon, silicon oxides, lithium titanate, and the like (see e.g., Nazri, 2009, referred to above).

Typically, the electrolyte comprises an electrolyte salt (e.g., an electrochemically stable lithium salt) dissolved in a non-aqueous solvent. Any lithium electrolyte salt can be utilized in the electrolyte compositions for lithium electrochemical cells and batteries, such as the salts described in Jow et al. (Eds.), Electrolytes for Lithium and Lithium-ion Batteries; Chapter 1, pp. 1-92; Springer; New York, NY (2014), which is incorporated herein by reference in its entirety.

Non-limiting examples of lithium electrolyte salts for the electrolyte include, e.g., lithium bis(trifluoromethanesulfonyl)imidate (LiTF SI), lithium 2-trifluoromethyl-4,5-dicyanoimidazolate (LiTDI), lithium 4,5-dicyano-1,2,3-triazolate (LiDCTA), lithium trifluoromethanesulfonate (LiTf), lithium perchlorate (LiClO₄), lithium bis(oxalato)borate (LiB(C₂O₄)₂ or “LiBOB”), lithium difluoro(oxalato)borate (LiF₂BC₂O₄ or “LiDFOB”), lithium tetrafluoroborate (LiBF₄), lithium hexafluorophosphate (LiPF₆), lithium hexafluoroarsenate (LiAsF₆), lithium thiocyanate (LiSCN), lithium bis(fluorosulfonyl)imidate (LiFSI), lithium bis(pentafluoroethylsulfonyl)imidate (LiBETI), lithium tetracyanoborate (LiB(CN)₄), lithium nitrate, combinations of two or more thereof, and the like. The lithium salt can be present in the electrolyte solvent at any concentration suitable for lithium battery applications, which concentrations are well known in the secondary battery art. In some embodiments, the lithium salt is present in the electrolyte at a concentration in the range of about 0.1 M to about 5 M, e.g., about 0.5 M to 2 M, or 1 M to 1.5M.

Non-aqueous solvents for the electrolyte compositions include the solvents described in Jow et al. (Eds.), Electrolytes for Lithium and Lithium-ion Batteries; Chapter 2, pp. 93-166; Springer; New York, NY (2014), which is incorporated herein by reference in its entirety. Non-limiting examples of solvents for use in the electrolytes include, e.g., an ether, a carbonate ester (e.g., a dialkyl carbonate or a cyclic alkylene carbonate), a nitrile, a sulfoxide, a sulfone, a fluoro-substituted linear dialkyl carbonate, a fluoro-substituted cyclic alkylene carbonate, a fluoro-substituted sulfolane, and a fluoro-substituted sulfone. For example, the solvent can comprise an ether (e.g., glyme or diglyme), a linear dialkyl carbonate (e.g., dimethyl carbonate (DMC), diethyl carbonate (DEC), ethyl methyl carbonate (EMC) and the like), a cyclic alkylene carbonate (ethylene carbonate (EC), propylene carbonate (PC) and the like), a sulfolane (e.g., sulfolane or an alkyl-substituted sulfolane), a sulfone (e.g., a dialkyl sulfone such as a methyl ethyl sulfone), a fluoro-substituted linear dialkyl carbonate, a fluoro-substituted cyclic alkylene carbonate, a fluoro-substituted sulfolane, and a fluoro-substituted sulfone. The solvent can comprise a single solvent compound or a mixture of two or more solvent compounds. In some embodiments, the organic solvent of the electrolyte to be recovered and recycled according to the methods described herein comprises about 3:7 (w/w) EC:EMC, sometimes referred to as Gen2, Gen 2, or Gen-2 solvent.

In some embodiments, the electrolyte to be recovered and recycled according to the methods described herein comprises about 1.2 M LiPF₆ dissolved in 3:7 (w/w) EC:EMC, sometimes referred to as Gen2, Gen 2, or Gen-2 electrolyte.

The electrolyte compositions for lithium electrochemical cells and batteries also can optionally comprise an additive such as those described in Jow et al. (Eds.), Electrolytes for Lithium and Lithium-ion Batteries; Chapter 3, pp. 167-182; Springer; New York, NY (2014), which is incorporated herein by reference in its entirety. Such additives can provide, e.g., benefits such as SEI, cathode protection, electrolyte salt stabilization, thermal stability, safety enhancement, overpotential protection, corrosion inhibition, and the like. The additive can be present in the electrolyte at any concentration, but in some embodiments is present at a concentration in the range of about 0.0001 M to about 0.5 M. In some embodiments, the additive is present in the electrolyte at a concentration in the range of about 0.001 M to about M, or about 0.01 M to about 0.1 M.

Lithium batteries can be housed in a variety of packaging configurations and materials including pouches, cylindrical cells, and prismatic cells. Cylindrical and prismatic cells have hard metallic enclosures, while lithium-ion pouch cells often are packaged using conductive multi-layer foil laminate materials. The electrical contacts of pouch cells are foil tabs welded to the electrodes and sealed to the pouch material. Cylindrical cells have a metal housing with at a resealable vent to release pressure under excessive charge. Prismatic cells are rectangular in shape, and typically have housings made of heavier gauge metals. The methods described herein can be used to recycle lithium cells and batteries with any of the typical cell geometries and housing/packaging types. If a housing material is too hard to be efficiently shredded, the housings can be opened and the internal battery components can be shredded separately.

The following non-limiting Examples are provided to illustrate certain features of the compositions and methods described herein.

### Example 1

A commercial cell with a NMC622 cathode with about 60 Ah capacity that was cycled to 80% state of health was utilized for these experiments. The cell was discharged and had an open circuit voltage of about 2.8 V prior to shredding. The cell was shredded under argon in a custom dual shaft shredder from Franklin Miller with blades configured to create approximately 5/16× 5/16 inch shreds. After shredding the shreds were allowed to be gradually exposed to air by turning off the argon flow for 1 hr. After that the shreds were removed and transferred to an argon filled glovebox with <1 ppm H₂O and O₂. The shreds were then rinsed using anhydrous diethyl carbonate (Sigma Aldrich) to remove and recover the electrolyte. The recovered electrolyte was then reconcentrated under vacuum, and additional ethylene carbonate was added to create an approximately 1 M LiPF₆ in 1:1 EC:DEC electrolyte.

The rinsed shreds were then dried under vacuum at 80° C. and then sieved at 2.8 mm to remove fines in a vibratory sieve shaker (AS200 control, Retsch). The >2.8 mm fraction was then aspirated to remove the separator utilizing a custom-built aspirator apparatus. The cathode material was then separated from the shreds using a rare earth roll (Eriez) with a diameter of 6 inches and a peak field strength of 24,000 gauss. The splitter was set nearly vertically such that nonmagnetic material barely passed over it at a belt speed of 100 feet per minute. The material was passed over once and then the nonmagnetic fraction was cycled back through. Lastly, the magnetic fraction was passed back through the rare earth roll separator to remove any residual nonmagnetic contaminants.

The magnetic fraction was then processed through a rotary kiln to remove the binder and carbon black and thereby liberate the cathode active material. The 3-inch rotary kiln (Carbolite Gero) has three zones that were set to 350° C., 500° C., and 500° C. with a rotation speed of 2 rpm and an air flow of 5 Lpm. A quartz tube with 4 impressions along the length of the tube was used to help mix the material during the thermal processing. After the thermal processing the material was sieved at 45 μm. The <45 μm fraction was mixed with LiIH·H₂O (FMC, ground and sieved less than 45 μm) to restore the lithium content. ICP-MS was used to determine Li content, and this was used to determine the amount of LiOH added using the formula: Li content=(100*(1.05-lithium content)/2+8) wt. %. The material was then heat treated at 750° C. for 8 hr in a muffle furnace (Nabertherm) with an air flow of 200 Lph. The material was then rinsed with water for 5 min to remove surface lithium at a ratio of 1 mL H₂O per g of cathode, filtered and rinsed further in the funnel with two more portions of water. The washed material was dried under vacuum at 80° C. and then annealed at 700° C. for 8 hr. This material was then used to make half-cell and full-cell coin cells with a 90:5:5 active to PVDF to C45 carbon black weight ratio using both 1.2 M LiPF₆ in 3:7 EC:EMC and the recycled electrolyte.

The nonmagnetic fraction was further processed by mixing the material in water with an acoustic mixer (RESODYN LABRAM II). This easily delaminates the anode material and breaks up clumps liberating more cathode material. The mixed material was sieved at 2.8 mm and the <2.8 mm fraction was filtered, and both fractions were dried under vacuum at 80° C. The >2.8 mm fraction was then passed back through the aspirator and rare earth roll using the same method as the original material to recover additional cathode material. The nonmagnetic fraction can then be sieved at 5.6 mm to remove most of the pouch cell material from the copper fraction.

### Example 2

The cathode active material recovered in Example 1 was sieved using a 45 μm sieve, and then was mixed with 5 wt % TIMCAL SUPER C45 carbon black and 5 wt % PVDF with sufficient NMP solvent to form a slurry. This slurry was coated onto aluminum foil and dried at 80° C. in air to form an electrode laminate. Electrodes were punched from the electrode laminate, calendared, and then further dried at 80° C. under vacuum in an argon-filled glovebox. Lithium half-cells were then prepared in that glovebox using lithium metal anodes and an electrolyte comprising 1.2 M LiPF₆ in 3:7 ethylene carbonate to ethyl methyl carbonate by volume. The cells were tested in triplicate using a MACCOR battery cycler at 30° C. A 1 C rate was assumed to be 160 mA/g. Full cells were made using a graphite electrode coated onto copper foil as the anode.

FIG. 6 provides a plot of discharge capacity versus cycle number for lithium half cells comprising recovered, relithiated NMC622 cycled at sequential rates of C/10, C/20, C/10, C/5, C/2, 1 C, 2 C, and C/3, showing a capacity of 177 mAh/g at C/10 cycling rate and 167 mAh/g at C/2 cycling rate.

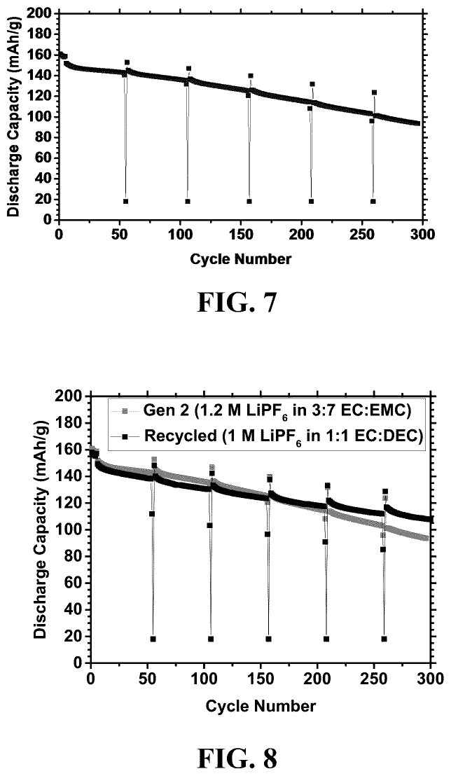

FIG. 7 provides a plot of discharge capacity versus cycle number for coin cells with Gen2 electrolyte (1.2 M LiPF₆ in 3:7 EC:EMC) at C/3 cycling rate (initial rate of C/10) with cathodes comprising recovered, relithiated NMC622, showing an initial capacity of 161 mAh/g at C/10 cycling rate and 152 mAh/g at C/3 cycling rate.

FIG. 8 provides a plot of discharge capacity versus cycle number for full cells with NMC622 cathode in pristine Gen2 electrolyte versus recovered electrolyte comprising 1 M LiPF₆ in 1:1 EC:DEC showing similar performance for the two electrolytes.

### Discussion

The results in FIG. 6 demonstrate that the addition of LiOH·H₂O substantially improves the performance of the cathode material after binder removal. With 4 wt. % LiOH·H₂O the initial capacity and rate performance of recovered NMC111 processed at 500° C. are similar to that of the pristine material. This is an indication that the cathode is not substantially doped by fluorine after the process is completed. In a separate experiment, a cathode composition comprising NMC622 processed in a similar manner required a temperature of 750° C. to 850° C. The results in FIG. 7 show that the higher temperature was necessary to obtain comparable recovered cathode material, demonstrating that different cathode compounds may require different processing parameters. The higher processing temperature for NMC622 was determined by routine process optimization experiments.

The results in FIG. 8 show that the recycled electrolyte can perform similarly to pristine simple electrolytes. There are slight differences between the two electrolytes with modestly poorer initial capacity for the recycled electrolyte, but lower capacity fading with cycling. This is an indicator that this electrolyte can be reused in new battery cells.

### Example 3

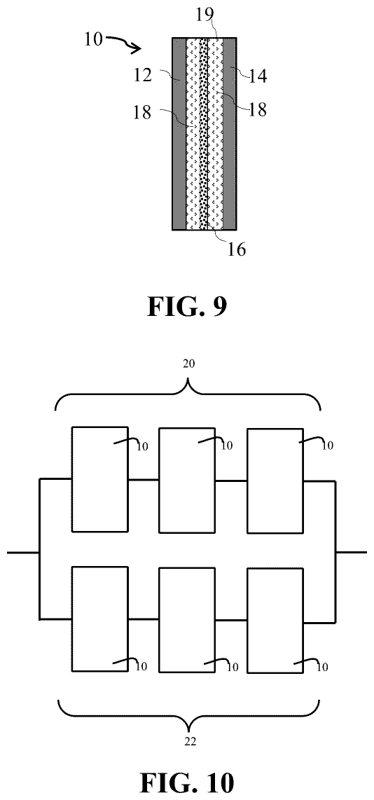

FIG. 9 schematically illustrates a cross-sectional view of an electrochemical cell 10 includes anode 12, and cathode 14 comprising a cathode active material, with separator 16 between anode 12 and cathode 14. A lithium-containing electrolyte 18, comprising a solution of a lithium salt in a non-aqueous solvent, contacts anode 12, cathode 14 and separator 16. The anode, cathode, separator and electrolyte are sealed within housing 19. FIG. 10 schematically illustrates a lithium-ion battery comprising a first array 20 consisting of three series-connected electrochemical cells 10, and a second array 22 consisting of three series-connected electrochemical cells 10, in which first array 20 is electrically connected to second array 22 in parallel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A recycling process for directly recycling lithium battery components from lithium batteries or lithium battery manufacturing scrap, wherein the batteries or scrap comprise a cathode comprising a cathode active material and carbon particles bound to an aluminum foil by a polymeric binder; an anode comprising an anode active material coated on a copper foil; and optionally: an electrolyte comprising a lithium electrolyte salt in a non-aqueous solvent; and a polymeric separator membrane; the process comprising the steps of:
(A) shredding lithium batteries or lithium battery manufacturing scrap;
(B) separating the electrolyte, if present, from the resulting shredded battery fragments by washing the fragments with an organic solvent;
(C) drying the resulting electrolyte-free fragments from step (B);
(D) removing at least a majority of separator membrane fragments from the resulting dried fragments of step (C) by aspiration with a stream of gas leaving a heavies composition;
(E) magnetically separating the heavies composition on a rare earth roll separator apparatus into a magnetic fraction comprising cathode fragments, and a non-magnetic fraction;
(F) removing the binder and carbon particles from the cathode fragments in the magnetic fraction;
(G) recovering the cathode active material remaining after step (F);
(H) relithiating the cathode active material; and
(I) recovering the resulting relithiated cathode active material.

2. The process of claim 1, wherein the binder and carbon are removed by heating the magnetic fraction under an oxygen-containing atmosphere at a temperature in the range of about 400 to about 1000° C. for a period of time sufficient to burn off the binder and carbon particles.

3. The process of claim 1, wherein the cathode active material is relithiated by adding a decomposable lithium-containing compound thereto and heating the resulting reaction mixture at a temperature in the range of about 400 to about 1000° C. for a period of time sufficient to fully lithiate the cathode active material.

4. The process of claim 1, further comprising recovering electrolyte removed in step (B), and adjusting the solvent and concentrations of the so-recovered electrolyte to obtain a target electrolyte composition.

5. The process of claim 1, further comprising washing the relithiated cathode active material recovered in step (I) with water.

6. The process of claim 1, further comprising annealing the relithiated cathode active material in step (I) at a temperature in the range of about 200 to about 1000° C. for up to about 24 hours.

7. The process of claim 1, further comprising separating and recovering aluminum foil from the relithiated cathode active material after step (H).

8. The process of claim 1, wherein the organic solvent in step (B) is selected from the group consisting of acetonitrile, dimethyl formamide, tetrahydrofuran, diethyl carbonate, ethyl methyl carbonate and dimethyl carbonate.

9. The process of claim 3, wherein the decomposable lithium-containing compound is a decomposable lithium salt, and the cathode active material is combined with about 1 to about 50 wt % of the decomposable lithium salt.

10. The process of claim 9, wherein the reaction mixture is heated under an oxygen-containing atmosphere to a temperature of about 400 to 1000° C. at a heating rate of about 30 to about 300° C./hour.

11. The process of claim 1, wherein the magnetic fraction obtained from step (E) is passed over the rare earth roll at least one additional time to separate additional non-magnetic fragments present therein.

12. The process of claim 1, wherein the non-magnetic fraction obtained from step (E) is passed over the rare earth roll at least one additional time to separate additional magnetic fragments present therein.

13. The process of claim 3, wherein the decomposable lithium-containing compound comprises at least one salt selected from the group consisting of lithium hydroxide hydrate, lithium carbonate, lithium nitrate, and a lithium salt of an organic acid.

14. The process of claim 1, wherein the cathode active material comprises LiFePO₄, or a material of empirical formula LiMO₂, wherein M comprises at least one transition metal.

15. The process of claim 14, wherein M comprises at least one transition metal selected from the group consisting of Ni, Mn, and Co.

16. The process of claim 2, wherein the heating is performed in a furnace, a fluidized bed reactor, or a rotary kiln.

17. The process of claim 3, wherein the heating is performed in a furnace, a fluidized bed reactor, or a rotary kiln.

18. The process of claim 1, further comprising the steps of:
(J) washing the non-magnetic fraction from step (E) with water in an acoustic mixer to remove the anode active material from the copper foil;
(K) drying solid materials remaining after step (J);
(L) removing additional separator membrane from the resulting dried solids from step (K) by aspiration with a stream of gas to produce a second heavies composition;
(M) passing the second heavies composition through a rare earth roll separator apparatus to remove additional magnetic cathode fragments therefrom; and
(N) sieving the second heavies composition from step (L) to separate and recover the copper foil from any other remaining materials in the heavies fraction.

19. The process of claim 18, further comprising recovering the anode active material from the water after step (J).

20. The process of claim 19, wherein the anode active material comprises graphite.

21. The process of claim 1, wherein the battery fragments have an average size in the range of about 0.25 to about 2 inches.

22. A method for separating cathodes from anodes in a lithium battery recycling process, wherein the cathodes comprise a delithiated cathode active material and carbon particles bound to an aluminum current collector by a polymeric binder; and the anodes comprise an anode active material coated on a copper current collector; the method comprising magnetically separating mixed fragments of anodes and cathodes on a rare earth roll separator apparatus into a magnetic fraction comprising cathode fragments, and a non-magnetic fraction comprising anode fragments.

23. The method of claim 22, wherein the fragments have an average size in the range of about 0.25 to about 2 inches.

24. The method of claim 23, wherein the magnetic fraction is magnetically separated at least one more time on the rare earth roll separator to remove additional non-magnetic material remaining in the magnetic fraction.

25. The method of claim 24, further comprising:
thermally removing the binder and carbon particles from the cathode in the magnetic fraction by heating the magnetic fraction under an oxygen-containing atmosphere at a temperature in the range of about 400 to about 1000° C. for a period of time sufficient to burn off the binder and carbon particles leaving cathode active particles and aluminum foil fragments;
recovering the cathode active particles;
recovering the aluminum foil fragments;
relithiating the delithiated cathode active material by adding a decomposable lithium-containing compound thereto and heating the resulting mixture at a temperature in the range of about 400 to about 1000° C. for a period of time sufficient to fully lithiate the partially delithiated cathode active material; and
recovering the resulting relithiated cathode active material.

26. The method of claim 22, wherein the non-magnetic fraction is magnetically separated at least one more time on the rare earth roll separator to remove additional magnetic material remaining in the non-magnetic fraction.

27. The method of claim 22, further comprising:
washing the non-magnetic fraction with water in an acoustic mixer to remove the anode active material from the copper foil; and
recovering the copper foil.

28. The method of claim 27, further comprising recovering the anode active material.

29. The method of claim 28, wherein the anode active material is graphite.

30. A cathode for a lithium battery comprising the relithiated cathode active material recovered in step (I) of the process of claim 1 and carbon particles coated on an aluminum current collector with a polymeric binder.

31. An electrolyte for a lithium electrochemical cell comprising the electrolyte recovered from the process of claim 4.

32. A lithium electrochemical cell comprising an anode, the cathode of claim 30, a lithium conductive separator membrane between the anode and the cathode, and a lithium containing electrolyte contacting the anode, the cathode, and the separator.

33. A lithium electrochemical cell comprising an anode, a cathode, a lithium conductive separator membrane between the anode and the cathode, and a lithium containing electrolyte contacting the anode, the cathode, and the separator, wherein the electrolyte comprises the electrolyte recovered from the process of claim 4.

34. A lithium battery comprising a plurality of the electrochemical cells of claim 33 electrically connected in series, in parallel, or in both series and parallel.

35. A lithium battery comprising a plurality of the electrochemical cells of claim 33 electrically connected in series, in parallel, or in both series and parallel.
